(19) United States
(12) Patent Application Publication
(10) Pub. No.: US 2017/0234575 A1
(43) Pub. Date: Aug. 17, 2017

(54) IN-LINE DUCT FILTER

(71) Applicant: Seal Tite LLC, Hillsboro, OH (US)

(72) Inventors: Russell L. Ihme, Martinsville, IN (US); Michael J. Kelley, Cincinnati, OH (US)

(73) Assignee: Seal Tite LLC, Hillsboro, OH (US)

(21) Appl. No.: 15/421,507

(22) Filed: Feb. 1, 2017

Related U.S. Application Data
(60) Provisional application No. 62/290,098, filed on Feb. 2, 2016.

(51) Int. Cl. F24F 13/28; B01D 46/00; F24F 7/04

(52) U.S. Cl. CPC F24F 13/28; F24F 7/04; B01D 46/0005; B01D 46/0012

(57) ABSTRACT

An in-line filter rack includes a chamber for housing at least one filter, an inlet opening providing access to the chamber and configured to be coupled to an upstream portion of a return air duct, and an outlet opening providing access to the chamber and configured to be coupled to a downstream portion of the return air duct.

### CROSS REFERENCE TO RELATED APPLICATION

This claims the benefit of U.S. Provisional Patent Application Ser. No. 62/290,098, filed Feb. 2, 2016 and hereby incorporated by reference in its entirety.

### TECHNICAL FIELD

This invention generally relates to air filters used in heating, ventilating, and air conditioning (HVAC) systems and, more particularly, to a filter rack for facilitating convenient access to filters contained therein and minimizing interference with components or other items in the vicinity of the HVAC system.

### BACKGROUND

HVAC systems have been used for many years to provide indoor environmental comfort and, more specifically, thermal comfort and acceptable indoor air quality. Air filters are a critical component to modern HVAC systems as they provide clean air to the people in the environment serviced by the HVAC system. Dirty, clogged filters restrict airflow to the system resulting in excess strain on the system and reduced efficiency, and could possibly shorten the mechanical life of the system. As such, HVAC equipment manufacturers recommend changing air filters as frequently as every three to four weeks.

Conventional HVAC systems include standard filter racks positioned so as to abut an HVAC appliance such as, for example, a furnace or air handler. More specifically, standard filter racks are positioned between the appliance and a return air duct which supplies return air to the appliance. These filter racks house one or more air filters, which trap particles and contaminants within the air immediately prior to the air entering the appliance. However, modern HVAC appliances have become very short, such that a standard filter rack abutting the appliance is undesirably located at or near the floor on which the appliance rests. This positioning of the air filter rack frequently interferes with other components of the HVAC system, gas lines, static/electric wires, condensate drains, and other components or items in the vicinity of the HVAC system. Thus, HVAC contractors, owners, designers, and/or engineers may have difficulty designing and installing the HVAC system.

Moreover, the positioning of standard filter racks at or near the floor is inconvenient for consumers. Specifically, changing air filters requires removing the existing filter(s) from the filter rack, discarding the used filter, and installing a replacement filter in the filter rack. While this process is not particularly complicated, many consumers fail to replace air filters at the recommended frequency to maintain clean airflow into the HVAC system. The inconvenience associated with accessing a standard filter rack which is on or near the floor and which may be obstructed by other nearby components exacerbates this failure, and thus contributes to increased energy consumption, poor heating/cooling quality, and increased maintenance and repair costs.

It would therefore be desirable to provide a filter rack for facilitating convenient access to filters contained therein and minimizing interference with components or other items in the vicinity of the HVAC system.

### SUMMARY

In one embodiment, an in-line filter rack includes a chamber for housing at least one filter, an inlet opening providing access to the chamber and configured to be coupled to an upstream portion of a return air duct, and an outlet opening providing access to the chamber and configured to be coupled to a downstream portion of the return air duct. The in-line filter rack may further comprise a filter door for providing selective access to the chamber when the filter rack is installed. The filter door may be biased toward a closed position. In addition or alternatively, the filter door may include at least one of a clasp or a lock for maintaining the filter door in a closed position. In one embodiment, the inlet opening and the outlet opening are sized and shaped to form airtight connections with the upstream and downstream portions of the return air duct, respectively.

In another embodiment, an HVAC system comprises an HVAC appliance positioned on a surface and a return air duct for supplying air to the HVAC appliance and including an upstream portion and a downstream portion. The downstream portion is coupled to the HVAC appliance. The HVAC system further comprises an in-line filter rack positioned between the upstream and downstream portions of the return air duct, wherein the in-line filter rack includes at least one filter. The in-line filter rack may be positioned above the surface. For example, the in-line filter rack may be positioned approximately 2 feet above the surface. In one embodiment, an airtight seal is provided between the in-line filter rack and each of the upstream and downstream portions of the return air duct.

In another embodiment, a method of installing an in-line filter rack for an HVAC system including an HVAC appliance positioned on a surface and a return air duct for supplying air to the HVAC appliance comprises inserting the in-line filter rack between upstream and downstream portions of the return air duct. For example, inserting the in-line filter rack between the upstream and downstream portions of the return air duct may include splicing the return air duct to form the upstream and downstream portions of the return air duct. In one embodiment, inserting the in-line filter rack between the upstream and downstream portions of the return air duct includes positioning the in-line filter rack above the surface. For example, inserting the in-line filter rack between the upstream and downstream portions of the return air duct may include positioning the in-line filter rack approximately 2 feet above the surface. In one embodiment, the method further comprises providing an airtight seal between the in-line filter rack and each of the upstream and downstream portions of the return air duct.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a side elevation view of a portion of an HVAC system including an exemplary in-line filter rack according to one embodiment of this invention; and

FIG. 2 is a perspective view of the in-line filter rack of FIG. 1.

### DETAILED DESCRIPTION

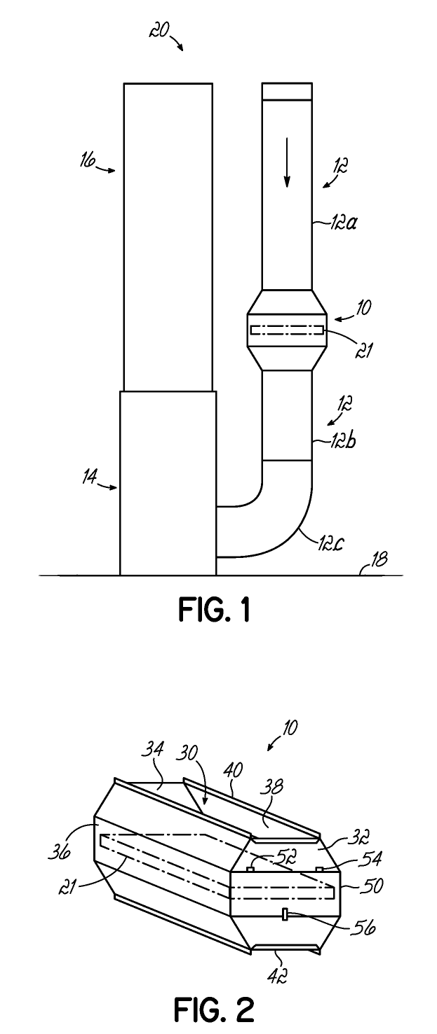

With reference to FIGS. 1 and 2, one embodiment of an in-line filter rack to according to this invention is designed to be positioned in-line with a return air duct 12 of an HVAC appliance, such as an air handler or furnace 14. By positioning the filter rack to in-line with the return air duct 12 and spaced upstream from, rather than abutting, the air handler or furnace 14, the filter rack to may be located off the floor and therefore provide convenient access to the filter(s) contained therein and minimal interference with other components of the HVAC system 20, gas lines, static/electric wires, condensate drains, and other components or items in the vicinity of the HVAC system 20. The features of the in-line filter rack to are set forth in further detail below to clarify each of these functional advantages and other benefits provided in this disclosure.

As shown in FIG. 1, the HVAC system 20 includes the return air duct 12, the in-line filter rack to, an HVAC appliance, such as, for example, the furnace 14, and a supply plenum 16. The furnace 14 is mounted on a floor 18. The return air duct 12 supplies air to the furnace 14 in the direction indicated by the arrow, where it is heated and directed into the environment to be serviced via the supply plenum 16. Prior to entering the furnace 14, the air passes through the filter rack to which contains at least one air filter 21 for cleaning the air by trapping particles and/or contaminants in the air.

As shown in FIG. 2, the in-line filter rack to includes a chamber 30 for housing at least one filter 21. The chamber 30 is partially enclosed by front, rear, and side walls 32, 34, 36, 38, with inlet and outlet openings 40, 42 providing airflow access to the chamber 30. While the shape of the in-line filter rack to may vary depending on the application, the inlet and outlet openings 40, 42 may be sized and shaped to form an airtight connection with adjacent portions of the return air duct 12. The in-line filter rack to may also be shaped according to the size of the air filters to be contained therein. For example, in the embodiment shown the air filters 21 to be housed in the chamber 30 may be of a size greater than the cross sections of the inlet and outlet openings 40, 42. Thus, the sidewalls 36, 38 may expand outwardly so that the front and rear walls 32, 34 have a generally hexagonal shape, as shown. In this manner, the in-line filter rack to may accommodate air filter(s) 21 designed for use in standard filter racks.

The filter rack to includes a filter door 50 attached to the front wall 32 via hinges 52, 54 for providing access to the chamber 30 when the filter rack to is installed in-line with the return air duct 12. A gasket (not shown) may be provided along the outer periphery of the filter door 50 in order to provide an airtight seal. In one embodiment, the hinges 52, 54 may be spring hinges for biasing the filter door 50 toward its closed position to ensure that the filter door 50 remains closed during continued operation of the HVAC system 20. In addition or alternatively, the filter door 50 may include a clasp or lock 56 for this purpose and/or to prevent tampering with the air filters.

With reference again to FIG. 1, the filter rack to may be installed in-line with the return air duct 12 at a location spaced upstream from the furnace 14. More specifically, the filter rack to is coupled to upstream and downstream portions 12, 12b of the return air duct 12 such that the inlet opening 40 of the filter rack to forms an airtight connection with the upstream portion 12a and the outlet opening 42 forms an airtight connection with the downstream portion 12b. In one embodiment, this may be accomplished by splicing a pre-existing return air duct 12 to form the upstream and downstream portions 12a, 12b, and inserting the filter rack to therebetween. Thus, air traveling through the return air duct 12 is directed from the upstream portion 12a into the filter rack to, where it is cleaned by the filter(s) 17 contained therein, and continues through the downstream portion 12b and into the furnace 14. As shown, the downstream portion 12b of the return air duct 12 may include an elbow 12c such as, for example, a Sealtite Inside Radius Short Way Elbow, to efficiently direct the air into the furnace 14.

While the exact positioning of the filter rack to in-line with the return air duct 12 may vary depending on the application, the filter rack to should be positioned at a sufficient height to facilitate convenient access to the filter(s) 21 via the filter door 50 and to avoid interference with other components or items in the vicinity of the HVAC system 20. In particular, the filter rack to should be positioned at an appreciable height off the floor 18. For example, in one embodiment the filter rack to may be positioned at least approximately 2 feet or more above the floor 18.

Although the HVAC appliance of the HVAC system 20 is described herein as a furnace 14, other HVAC appliances such as, for example, an air handler, may be used without departing from the scope of the invention.

While this invention has been illustrated by a description of various embodiments and while these embodiments have been described in some detail, it is not the intention of the inventors to restrict or in any way limit the scope of the appended claims to such detail. Additional advantages and modifications will readily appear to those skilled in the art. The various features of the invention may be used alone or in numerous combinations depending on the needs and preferences of the user.

What is claimed is:

1. An in-line filter rack comprising:
a chamber for housing at least one filter;
an inlet opening providing access to the chamber and configured to be coupled to an upstream portion of a return air duct; and
an outlet opening providing access to the chamber and configured to be coupled to a downstream portion of the return air duct.

2. The in-line filter rack of claim 1, further comprising a filter door for providing selective access to the chamber when the filter rack is installed.

3. The in-line filter rack of claim 2, wherein the filter door is biased toward a closed position.

4. The in-line filter rack of claim 2, wherein the filter door includes at least one of a clasp or a lock for maintaining the filter door in a closed position.

5. The in-line filter rack of claim 1, wherein the inlet opening and the outlet opening are sized and shaped to form airtight connections with the upstream and downstream portions of the return air duct, respectively.

6. An HVAC system comprising:
an HVAC appliance positioned on a surface;
a return air duct for supplying air to the HVAC appliance and including an upstream portion and a downstream portion, wherein the downstream portion is coupled to the HVAC appliance; and
an in-line filter rack positioned between the upstream and downstream portions of the return air duct at a position spaced from the HVAC appliance, wherein the in-line filter rack includes at least one filter.

7. The HVAC system of claim 6, wherein the in-line filter rack is positioned above the surface.

8. The HVAC system of claim 7, wherein the in-line filter rack is positioned approximately 2 feet above the surface.

9. The HVAC system of claim 6, wherein an airtight seal is provided between the in-line filter rack and each of the upstream and downstream portions of the return air duct.

10. A method of installing an in-line filter rack for an HVAC system including an HVAC appliance positioned on a surface and a return air duct for supplying air to the HVAC appliance, the method comprising:
inserting the in-line filter rack between upstream and downstream portions of the return air duct at a location spaced from the HVAC appliance.

11. The method of claim 10, wherein the inserting the in-line filter rack between the upstream and downstream portions of the return air duct step includes splicing the return air duct to form the upstream and downstream portions of the return air duct.

12. The method of claim 10, wherein the inserting the in-line filter rack between the upstream and downstream portions of the return air duct step includes positioning the in-line filter rack above the surface.

13. The method of claim 12, wherein the inserting the in-line filter rack between the upstream and downstream portions of the return air duct step includes positioning the in-line filter rack approximately 2 feet above the surface.

14. The method of claim 10, further comprising:
providing an airtight seal between the in-line filter rack and each of the upstream and downstream portions of the return air duct.
